(19) United States
(12) Patent Application Publication
(10) Pub. No.: US 2018/0139408 A1
(43) Pub. Date: May 17, 2018

(54) Video-Based Song Comparison System

(71) Applicant: Parrotty, LLC, New City, NY (US)

(72) Inventor: Doron Fetman, Monsey, NY (US)

(21) Appl. No.: 15/809,221

(22) Filed: Nov. 10, 2017

Related U.S. Application Data
(60) Provisional application No. 62/423,433, filed on Nov. 17, 2016.

(51) Int. Cl. H04N 5/92; H04N 5/775; G06F 17/30

(52) U.S. Cl. CPC H04N 5/9202; H04N 5/9205; G06F 3/04842; G06F 17/30787; G06F 17/30843; H04N 5/775

(57) ABSTRACT

An improved video-based song comparison system is described. The video-based song comparison system is a technology platform that may allow users to search, submit, and vote on two songs compared within a comparison video (“set”). The two songs in a “set” are voted on by users as to whether they are “similar,” “sampled” or “stolen” in comparison to each other. Additionally, the system allows users to create their own “sets” by uploading or choosing songs contained within videos, dragging the songs together to create an overlap, adding video transitions, and tagging the set with both song's meta information including artists, albums, album images and song titles.

### RELATED APPLICATION

This application claims the benefit of U.S. Provisional Patent Application Ser. No. 62/423,433 filed on Nov. 17, 2016.

### FIELD OF THE DISCLOSURE

The present disclosure relates generally to an apparatus, method, and system for a video-based song comparison.

### BACKGROUND

It is well known that one song may sound like another song. This may be incidental or quite extensive, depending on the nature of the two songs. It is therefore desirable to construct a system where songs may be compared side by side in one video. This system may also involve social media with voting processes and the ability for users to upload their own song comparisons.

This video-based song comparison system (which may be called PARROTTY™) is a technology platform that may allow users to search, submit, and vote on two songs compared within a comparison video (“set”). The two songs in a “set” are voted on by users as to whether they are “similar,” “sampled” or “stolen” in comparison to each other. Additionally, the system allows users to create their own “sets” by uploading or choosing songs contained within videos, dragging the songs together to create an overlap, adding video transitions, and tagging the set with both song's meta information including artists, albums, album images and song titles.

The system solves the problem of determining whether one song is sampled, similar or stolen to another song through aggregating user's votes and by allowing users to upload and create pre-tagged “sets” that explicitly allow users to hear the difference between songs that might be “sampled, stolen, or similar” to each other. This is all done through a website application with social sharing functionality, which allows for many users to quickly determine outcomes in song comparison without lengthy polling or debate. A custom video editor allows users to quickly create their own comparisons for sharing as well.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system diagram for submitting video-based songs for comparison, in accordance with some embodiments.

FIG. 2 is a mock-up of submitting video-based songs for comparison, in accordance with some embodiments.

FIG. 3 is a mock-up of preparing a reference video-based song for comparison, in accordance with some embodiments.

FIG. 4 is a mock-up of preparing an original video-based song for comparison, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

### I. DESCRIPTION OF COMPARISON PROCESS

A. Choosing Songs to Compare

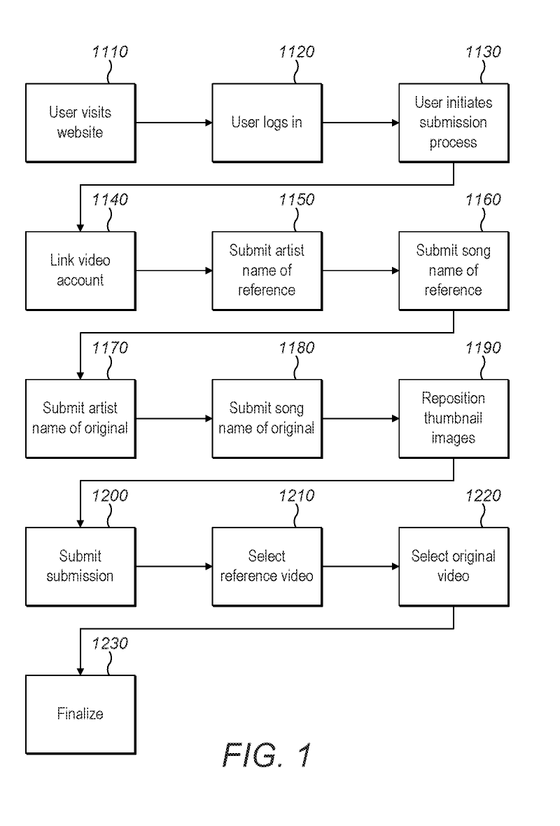

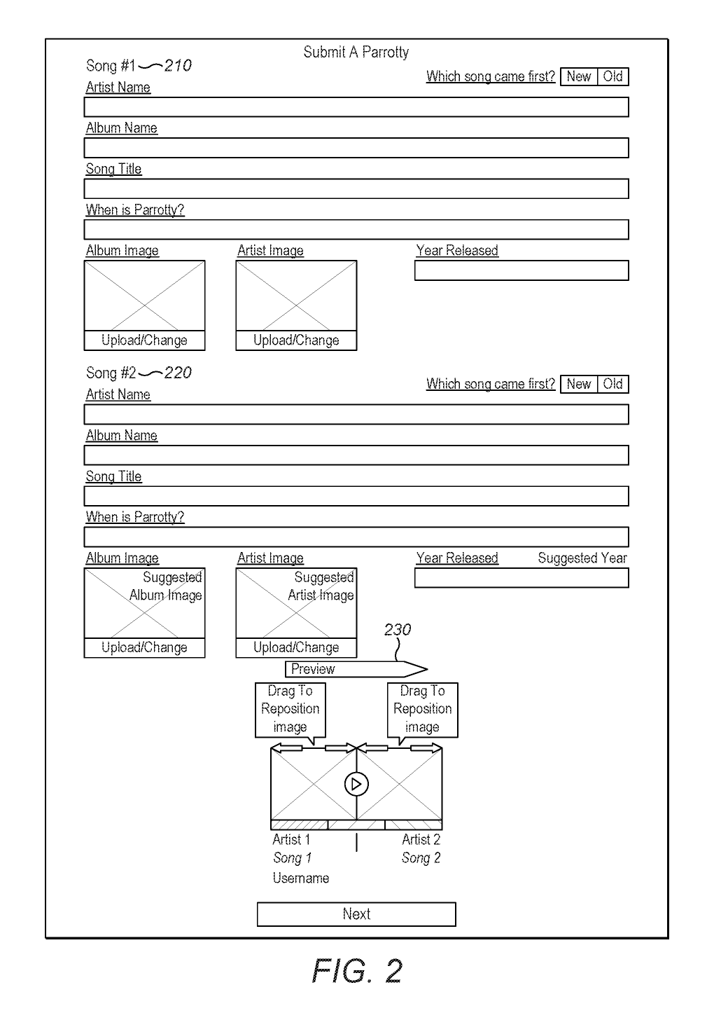

Turning to FIG. 1, shown is a system workflow diagram for an apparatus, method, and system for submitting a video-based song comparison. Turning to FIG. 2, shown is a mock-up of submitting video-based songs for comparison.

A user may access the video-based song comparison system by visiting the site from their internet browser, app, or other means 1110. Once connected to the site, the user may be prompted to enter their username and password to gain entry to their account. 1120. If the user does not already have an account, the user may be asked to create one. Once logged in, the user may initiate the submission process by clicking on, or otherwise selecting, the appropriate button or link on the site 1130.

Once on the submission page, the user may be asked to establish a link to a YouTube, or other similar streaming video site, account and/or channel. This may be accomplished by prompting the user to enter credentials for the video streaming account, and agreeing to allow the video-based comparison system to access that account 1140.

The user may now enter the name of the artist of the “reference” song 210, which may be through a text field that automatically searches for matches as the user inputs the artist name (autocomplete feature) 1150. The user may select the name of any of the search results or continue inputting letters until the desired artist name is found and selected. Once the artist has been selected, the user may now enter the name of the song of the “reference” song, which may be through a text field that automatically searches for matches as the user inputs the song name 1160. The user may select the name of any of the search results or continue inputting letters until the desired song name is found and selected.

The user may now enter the name of the artist of the “original” song 220, which may be through a text field that automatically searches for matches as the user inputs the artist name (autocomplete feature) 1170. The user may select the name of any of the search results or continue inputting letters until the desired artist name is found and selected. Once the artist has been selected, the user may now enter the name of the song of the “original” song, which may be through a text field that automatically searches for matches as the user inputs the song name 1180. The user may select the name of any of the search results or continue inputting letters until the desired song name is found and selected.

As the user chooses the two songs, they may use the system using an electronic submission form. The system may then obtain autocomplete information about the two songs (including details regarding album, artist, song and date) from a third-party service provider. Users may manually add a different set of details to the songs if the autocomplete from a third-party service does not have information on the chosen songs. The user or system chooses which song is “Old” and which song is “New” at this stage as well.

Once both the “reference” and “original” songs have been selected, the user may be able to reposition the thumbnail image for each artist that have been provided 1190. The user may reposition the artist, some or album images within the set frame so the most relevant 50% of each artist image is shown within the frame 230. The user may now choose to submit their selections and move to the next stage of the process 1200.

B. Creating a Composite Video

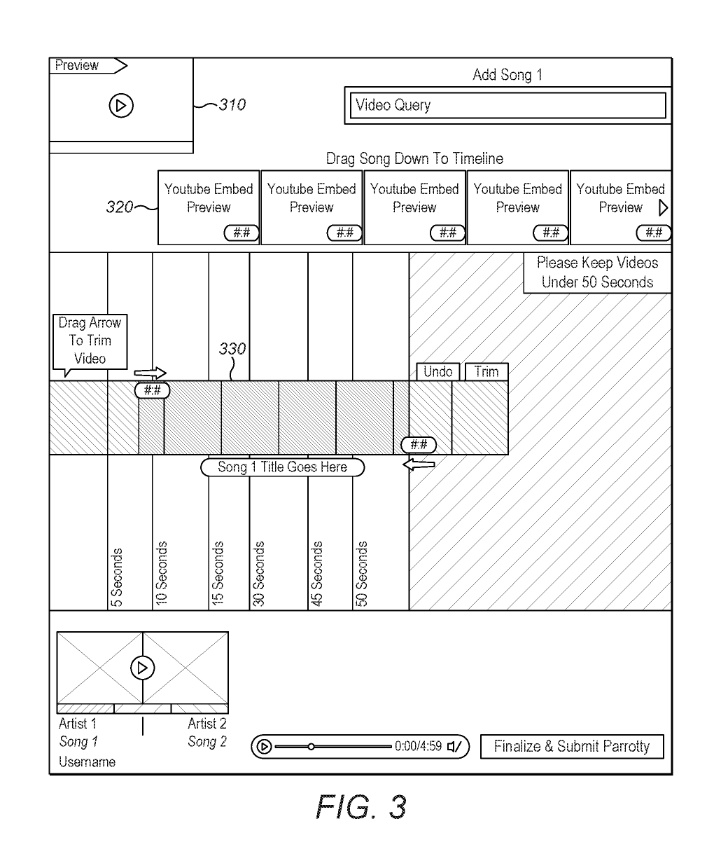

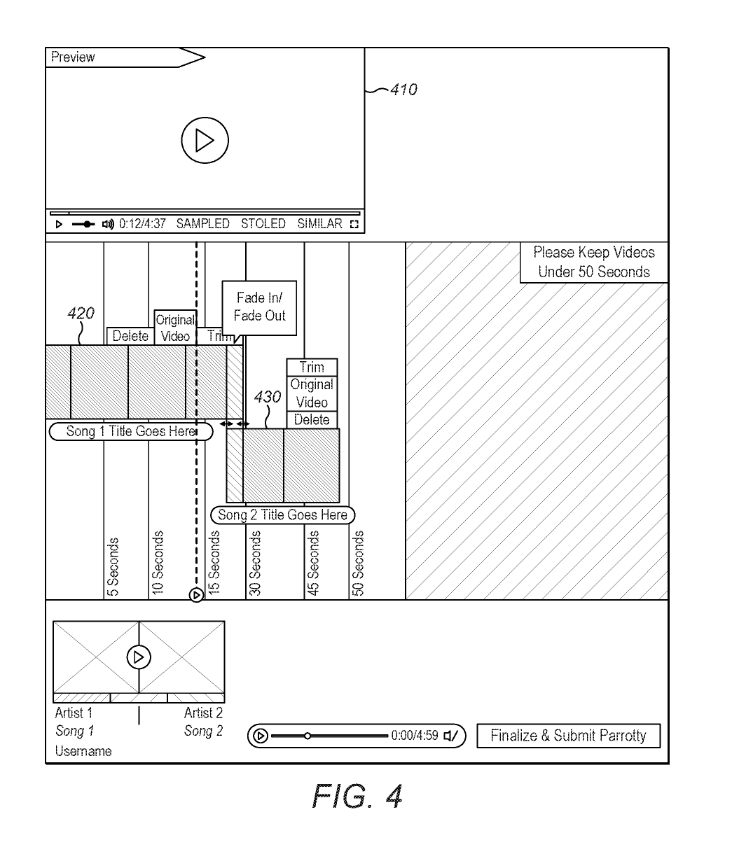

Turning to FIG. 3, shown is a mock-up of preparing a reference video-based song for comparison, in accordance with some embodiments. Turning to FIG. 4, shown is a mock-up of preparing an original video-based song for comparison, in accordance with some embodiments.

In this next step of the process, the user chooses a corresponding video or upload a video/song to pull in audio for each song chosen from step A, above. The user may clip the videos/songs so only the relevant similar pieces of audio are chosen. The user may overlap the videos/songs so there can be an audio fade between the first song and the second. When the user is satisfied that the set is complete, the user confirms the final set.

Specifically, the user may now select from a number of videos that match the search of the desired “reference” song 1210. From the interface, the user may be able to preview the selected video 310. The user may also be able to select the desired 15-second or less, or other duration, clip of the video, which may represent which portion of the song they believe to have been sampled 320, 330. Once the “reference” video and clip have been selected, the user may now select from a number of videos that match the search of the desired “original” song 1220. From the interface, the user may be able to preview the selected video 410. The user may also be able to select the desired 15-second or less, or other duration, clip of the video, which may represent which portion of the song they believe to have been sampled from 420, 430.

Once both video clips have been selected, the user may now preview the combined video. If the user is satisfied with the preview, the user may then finalize their selections and submit them 1230.

The user may have to pick less than 25 second clips from each video so that the total video length may be capped at 50 seconds.

The video may be made automatically with the following elements that may be added as overlays: selected audio, overlays with split view of artist images for two seconds, then pans of album images (video pan) which show during duration of each song, fade between album images for set fade between songs, then final vote to decide screen for one second.

The system allows the user to preview the finalized overlapped video in, for example, the top left corner of their screen.

The user finalizes their set and publishes it to the site and the video is linked to their site profile.

The system may then merge the two video clips and may also add them to the user's video streaming account that was linked earlier. The combined clip may now be available on the video-based song comparison site for other users to view as well.

### II. SITE FEATURES

A. The site may use a custom video player that allows a user to vote in a video comparison that may use a HTML5-based player that pulls video from external video accounts at video repositories such as YouTube and Amazon CloudFront. The player may also have a flash design which allows it to play with its styling when posted on Facebook walls or on other social media.

B. The site may include a recommendation engine which is used to calculate which sets should be shown to a user.

C. The site may use a sync script which syncs YouTube videos uploaded by admin or submitted by users to the contest to be uploaded to the PARROTTY video server (whether its own site or hosted by a third party).

D. The site includes a video upload submission form which allows two videos to be uploaded, for sounds to be extracted from the videos, and for the songs to be edited and overlapped in a way that can then be created into one comprehensive video comparing the two songs.

E. The site may include “similar,” “sampled” and “stolen” vote buttons and a vote counting system allow users to compare if one song is sampled, stolen, or similar to another song.

F. The site may include a continuously playing playlist system which allows users to create a curated list of sets to play in series or to play a system generated playlist.

G. The site may include an internal comment system that utilizes social network logins and search-engine-optimization tagging to place sharing in social network feeds and search engine results.

### III. PLAYLIST SYSTEM PLAY QUEUE SYSTEM DESCRIPTION

A. Sets may always be playing continuously so that the user can see which songs are up next and can select from system-created playlists. For example, the sets may be sorted by recent uploads or top voted (whether the votes are for similar, sampled or stolen videos).

2. User profiles may contain playlist of all songs they received credit for submitting.

3. Users may save playlists, open up previously saved playlists or overwrite/add to previously save playlists.

4. Users may play a playlist of songs that are recommended for them based on the recommendation engine.

5. Users may add all songs in a system playlist to a saved playlist and may add individual sets to these playlists as well.

### IV. TECHNICAL BACKGROUND

The site may be built on a custom framework utilizing a Linux operating system, Apache HTTP Server, MySQL relational database management system, Swagger API system, AWS cloud hosting and video transcription services, and external social APIs such as Facebook.

### V. CONCLUSION

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I claim:

1. A method comprising:
selecting a first video having a first audio stream;
selecting a second video having a second audio stream;
selecting a first portion from the first video comprising a first audio stream portion;
selecting a second portion from the second video comprising a second audio stream portion;
creating a third video comprising the first video portion followed by the second video portion;
querying whether the first audio stream portion and the second audio stream portion are related.

2. The method as in claim 1 wherein selecting a first video involves the use of an autocomplete feature and wherein selecting a second video involves the use of an autocomplete feature.

3. The method as in claim 2, wherein selecting a first portion from the first video involves a first thumbnail image and a second portion from the second video involves a second thumbnail image.

4. The method as in claim 3, wherein creating a third video involves editing the first thumbnail image and involves editing the second thumbnail image.

5. The method as in claim 4, further comprising associating the third video with an external video account.

6. The method as in claim 5, wherein the third video further comprises an audio fade between the first audio stream portion and the second audio stream.

7. The method as in claim 6, wherein the first video portion comprises a first image related to the first audio stream and the second video portion comprises a second image related to the second audio stream.

8. The method as in claim 7, wherein the third video further comprises a video pan of the first image and a video pan of the second image.

9. The method as in claim 8, wherein the first video portion is 15 seconds or less and wherein the second video portion is 15 seconds or less.

10. The method is in claim 9 wherein querying whether the first audio stream portion and the second audio stream portion are related comprises the use of a similar vote button, a sampled vote button, and a stolen vote button.

11. A system comprising:
a first video having a first audio stream;
a second video having a second audio stream;
a first portion from the first video comprising a first audio stream portion;
a second portion from the second video comprising a second audio stream portion;
a third video comprising the first video portion followed by the second video portion;
a query whether the first audio stream portion and the second audio stream portion are related.

12. The system as in claim 11 wherein creation of the first video involves the use of an autocomplete feature and wherein creation of the second video involves the use of an autocomplete feature.

13. The system as in claim 12, wherein the first portion from the first video includes a first thumbnail image and the second portion from the second video includes a second thumbnail image.

14. The system as in claim 13, wherein creating the third video involves editing the first thumbnail image and involves editing the second thumbnail image.

15. The system as in claim 14, further comprising an association of the third video with an external video account.

16. The system as in claim 15, wherein the third video further comprises an audio fade between the first audio stream portion and the second audio stream.

17. The system as in claim 16, wherein the first video portion comprises a first image related to the first audio stream and the second video portion comprises a second image related to the second audio stream.

18. The system as in claim 17, wherein the third video further comprises a video pan of the first image and a video pan of the second image.

19. The system as in claim 18, wherein the first video portion is 15 seconds or less and wherein the second video portion is 15 seconds or less.

20. The system is in claim 19 wherein the query whether the first audio stream portion and the second audio stream portion are related comprises the use of a similar vote button, a sampled vote button, and a stolen vote button.
